(19) United States
(12) Patent Application Publication
(10) Pub. No.: US 2018/0072207 A1
(43) Pub. Date: Mar. 15, 2018

(54) FORMING OF FOAM UPHOLSTERY FOR A MOTOR VEHICLE SEAT ELEMENT

(71) Applicant: Faurecia Sieges D'Automobile, Nanterre (FR)

(72) Inventors: Jean-Marie MAUFFREY, VALDORE (FR); Quentin PARRAIN, LUXEUIL LES BAINS (FR); Mathieu BOQUET, VERRIERES LE BUISSON (FR)

(21) Appl. No.: 15/690,063

(22) Filed: Aug. 29, 2017

(30) Foreign Application Priority Data
Sep. 9, 2016 (FR) 16/58440

(51) Int. Cl. B60N 2/70; B29C 44/42; B29C 44/14

(52) U.S. Cl. CPC B60N 2/7017; B29C 44/42; B29L 2031/58; B29K 2603/00; B29K 2623/06; B29C 44/14

(57) ABSTRACT

A method of forming upholstery of a foam seat element including the steps of: inserting, into an injection mold, a plastic film delimiting at least one first foam injection area; injecting foam to form the upholstery in one piece, the film disappearing with the polymerization of the foam.

This application claims the priority benefit of French patent application number 16/58440, the content of which is hereby incorporated by reference in its entirety to the maximum extent allowable by law.

### BACKGROUND

The present disclosure generally relates to motor vehicle seats and, more particularly, to the forming of foam upholstery of a seat element.

### DISCUSSION OF THE RELATED ART

More and more often, it is desired to form complex foam seat elements, be it to integrate various devices or fittings therein or to have foams having different densities.

The integration of an object in foam injected in one piece may raise an issue. Indeed, conventionally, the object cannot be placed in the mold before the foam injection since, during the injection, foam might reach portions of the device and hinder its subsequent operation. This is for example true when a three-dimensional textile is desired to be integrated to obtain a ventilation effect. The injected foam will tend to fill up the cells of the 3D textile.

In the case of the forming of a seat element with foams having different densities, it is difficult to define the border between two foams from the moment that they are injected at the same time into the same mold.

### SUMMARY

An embodiment aims at providing a method of forming upholstery of a seat element by foam injection which overcomes all or part of the disadvantages of usual methods.

An embodiment provides a solution particularly adapted to the forming of upholstery made of foams having different densities.

An embodiment provides a solution particularly adapted to the integration of a device in the upholstery.

Thus, an embodiment provides a method of forming upholstery of a foam seat element comprising the steps of:

inserting, into an injection mold, a plastic film delimiting at least one first foam injection area;

injecting foam to form the upholstery in one piece, the film disappearing with the polymerization of the foam.

According to an embodiment, the film is made of a mixture of polyethylene and of starch.

According to an embodiment, the film separates the foam injection area from an object.

According to an embodiment, the object is a 3D textile layer.

According to an embodiment, the film delimits the first injection area from at least one second foam injection area in the mold.

According to an embodiment, the foam injection areas are intended for foams having different densities.

According to an embodiment, a cover is placed at the bottom of the mold before injection.

An embodiment provides upholstery of a seat element, obtained by the implementation of the above method.

An embodiment provides a motor vehicle seat element comprising at least one piece of upholstery.

An embodiment provides a motor vehicle seat comprising at least one seat element.

The foregoing and other features and advantages will be discussed in detail in the following non-limiting description of dedicated embodiments in connection with the accompanying drawings.

### BRIEF DESCRIPTION OF THE DRAWINGS

FIG. 1 is a simplified representation of an embodiment of a step of foam injection into a mold, adapted for an injection of foams having different densities;

FIG. 2 is a simplified cross-section representation of the obtained upholstery;

FIG. 3 is a simplified representation of an embodiment of a step of foam injection, into a mold, with the integration of a three-dimensional textile element; and

FIG. 4 is an exploded perspective view of an embodiment of a seat element with a three-dimensional textile layer.

### DETAILED DESCRIPTION

For clarity, only those steps and elements which are useful to the understanding of the embodiments which will be described have been shown and will be detailed. In particular, the forming of the other seat elements, and particularly of the frame and of the cover, has not been detailed, the described embodiments being compatible with usual embodiments of such elements.

It should be noted that, in the drawings, the structural and/or functional elements common to the different embodiments may be designated with the same reference numerals and may have identical structural, dimensional, and material properties.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, it is referred, unless otherwise mentioned, to the orientation of the drawings or to a seat in its normal position of use. Unless otherwise specified, expressions approximately, substantially, and in the order of mean to within 10%, preferably to within 5%.

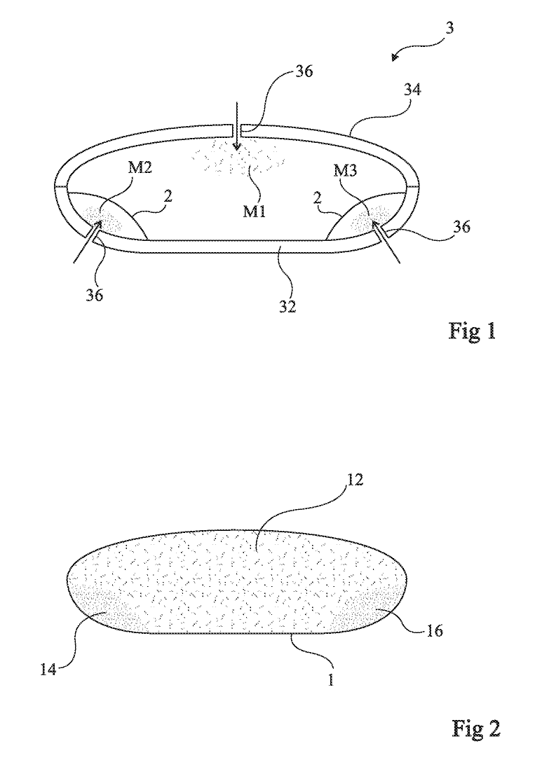

FIG. 1 is a simplified representation of an embodiment of a step of foam injection into a mold, adapted for the injection of foams having different densities. Term “injection” is used, but it should be understood that when reference is made to an injection, this also comprises foam spraying techniques, and other foam forming techniques.

According to this embodiment, it is desired to form three foam areas having different densities. This is an arbitrary example, and other configurations may be provided.

A foam injection mold 3 is used in the form, for example, of two shells 32 and 34, defining the shape of the upholstery and assembled to each other before the injection. Mold 3 is not modified by the implementation of the described embodiments. To inject three foams M1, M2, and M3 having different densities, mold 3 comprises at least three injection nozzles 36 arranged at the level of the corresponding areas.

In a conventional embodiment, the foams are injected at the same time or with a slight delay according to the areas. A difficulty is that the interfaces between areas are difficult to clearly and reproducibly define. This issue is particularly present at the edges of the mold, and thus of the upholstery.

According to the embodiment shown in FIG. 1, it is provided to arrange, in the mold before the injection of foams M1, M2, and M3, one or a plurality of plastic film parts 2 to define a border between foams during the injection. The presence of the film avoids for the foams to mix during the injection.

The material of film 2 is selected on the one hand to be foam-tight during the injection but also to degrade during the polymerization of the foam.

It is, for example, a film made up of polyethylene and starch which has the specificity of disappearing when the foam polymerizes or, more specifically, of integrating to the foam.

If no film which degrades during the polymerization is used, the foam areas would remain separated and would not adhere together.

FIG. 2 is a simplified cross-section representation of the obtained upholstery. As illustrated in this drawing, seat element 1 has three areas 12, 14, and 16 of foams having different densities. The areas are perfectly defined due to film 2, which was present at the molding. However, the foams are also joined at their interface due to the disappearing of film 2 during the polymerization.

A lining material made of woven or nonwoven textile, of skin, or of a synthetic material may be arranged, before the foam injection, at the bottom of mold 3 to directly form the cover around the upholstery.

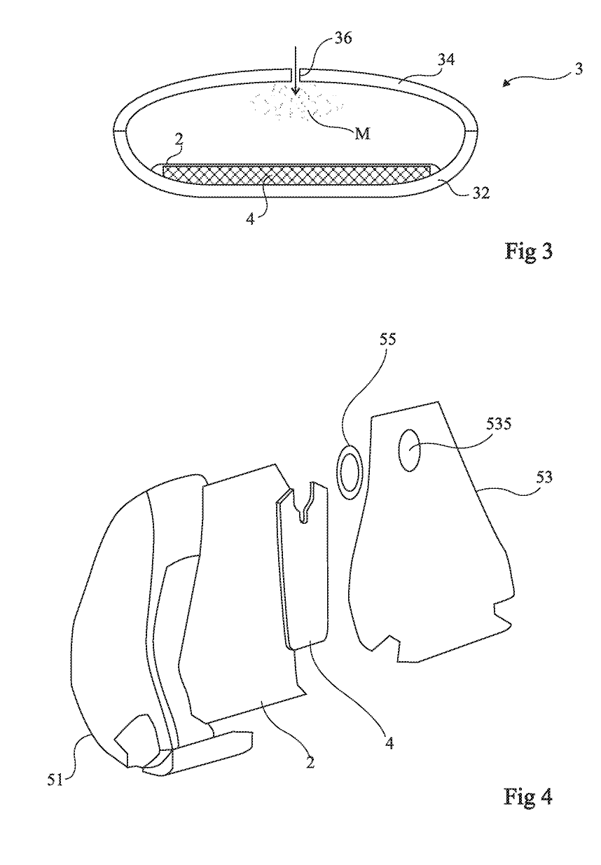

FIGS. 3 and 4 illustrate another application of the use of a separation film during the molding. According to this example, it is desired to integrate, in a surface of the upholstery, an object, for example, a 3D textile to be used as areas of ventilation (heating or cooling) of the seat element.

FIG. 3 is a simplified representation of an embodiment of a step of foam injection, into a mold, with the integration of a three-dimensional textile element.

In a conventional embodiment, thermoforming layers have to be used to attach the three-dimensional textile to the upholstery. This complicates the manufacturing.

According to the embodiment illustrated in FIG. 3, a three-dimensional textile layer 4 is placed at the bottom of one of the shells 32 of a foam injection mold 3. Then, the 3D textile is protected by a film 2 before injecting foam M.

During the foam injection, for example, by a nozzle 36, the foam is retained by film 2, which avoids filling the cells of the 3D textile.

According to an embodiment, film 2 is made of plastic, for example, of polyurethane, of linear low-density polyethylene (LLDPE), of low-density polyethylene (LDPE). According to this embodiment, film 2 remains once the element has been finished.

According to another preferred embodiment, film 2 is, as in the embodiment of FIGS. 1 and 2, made of a material which degrades once the foam has polymerized. The fact for film 2 to disappear favors air exchanges between the 3D textile and the foam layer.

FIG. 4 is an exploded perspective view of a seat element, for example, a backrest, fitted at the back with a three-dimensional textile to create an air flow in the backrest.

The case where plastic film 2 remains at the end of the manufacturing is assumed. A foam layer 51 is thus present at the front of the backrest. The back of layer 51 is separated from 3D textile layer 4 by film 2. The back of layer 4 is covered with a protection, for example, duffel 53. Preferably, an opening 535 for receiving a ventilation grid 55 communicating with the 3D textile is provided in layer 53.

An advantage is that it is now possible to form a seat element in one piece by foam injection, including while integrating a device inside of it. The manufacturing is considerably simplified.

Various embodiments have been described. Various alterations, modifications, and improvements will occur to those skilled in the art. In particular, the forming of the actual foam has not been discussed, the described embodiments being per se compatible with usual forming methods. Further, the practical implementation of the described embodiments is within the abilities of those skilled in the art based on the functional indications given hereabove, be it for molding techniques or for the selection of the material forming the film.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method of forming upholstery of a foam seat element comprising the steps of:
inserting, into an injection mold, a plastic film delimiting at least one first foam injection area;
injecting foam to form the upholstery in one piece, the film disappearing with the polymerization of the foam.

2. The method of claim 1, wherein the film is made of a mixture of polyethylene and of starch.

3. The method of claim 1, wherein the film separates the foam injection area from an object.

4. The method of claim 3, wherein the object is a 3D textile layer.

5. The method of claim 1, wherein the film delimits the first injection area from at least one second foam injection area in the mold.

6. The method of claim 5, wherein the foam injection areas are intended for foams having different densities.

7. The method of claim 1, wherein a cover is placed at the bottom of the mold before the injection.

8. Upholstery for a seat element, obtained by the implementation of the method of claim 1.

9. A motor vehicle seat element comprising at least one piece of upholstery of claim 8.

10. A motor vehicle seat comprising at least one seat element of claim 9.
